(19) United States
(12) Patent Application Publication
(10) Pub. No.: US 2019/0359770 A1
(43) Pub. Date: Nov. 28, 2019

(54) SULPHUR-CONTAINING POLYAMIDES AND METHODS FOR PRODUCING THE SAME

(71) Applicant: Neste Corporation, Espoo (FI)

(72) Inventors: Jukka SEPPÄLÄ, Espoo (FI); Steven SPOLJARIC, Otaniemi (FI); Phan Huy NGUYEN, Espoo (FI); Tomi NYMAN, Vantaa (FI); Perttu KOSKINEN, Helsinki (FI)

(73) Assignee: Neste Corporation, Espoo (FI)

(21) Appl. No.: 16/331,384

(22) PCT Filed: Sep. 7, 2017
(86) PCT No.: PCT/FI2017/050633

§ 371 Date: Mar. 7, 2019

(30) Foreign Application Priority Data
Sep. 8, 2016 (FI) 20165671

(51) Int. Cl. C08G 69/42

(52) U.S. Cl. CPC C08G 69/42

(57) ABSTRACT

The present invention relates to the preparation of novel sulphur-containing polyamides from renewable sources, and methods for producing the same. The production method involves the preparation of sulphur-containing functional monomers, which can subsequently undergo polycondensation to from either AB- or AABB-type sulphur-containing polyamides. Furthermore, these novel polyamides display superior water barrier/adsorption, better retention of physical properties at elevated temperature (≥T_{g}) and easier processability and polyolefin-compatibility than conventional polyamides. Potential applications for these novel polyamides include high-end electronic devices, organic light-emitting diode devices, components for charge-coupled devices (CCDs) and image sensors (CISs), films and coatings, food packaging films, furniture, appliances, sports equipment, consumer goods, wire and cable, and automotive components.

### FIELD OF THE INVENTION

The invention relates to novel aliphatic long-chain polyamides which contain sulphur along the main chain, and methods for producing the same.

### BACKGROUND OF THE INVENTION

Polyamides, better known under the generic name ‘nylons’ are a major class of engineering thermoplastics. They show excellent properties, such as high strength, flexibility and toughness, relative high melting points, good heat resistance and abrasion resistance, and chemical inertness. The major drawback of the polyamides is their ability to absorb moisture which has a detrimental influence on dimensional stability as well as mechanical, chemical and physical properties.

Typically, polyamides are prepared via a polycondensation reaction in which diamine and dicarboxylic acid groups react to form a polymer linked through amide linkages, releasing water as a by-product. The amine group and the carboxylic acid group can be present as separate monomers (namely, as diamine and dicarboxylic acid molecules) or within the same, single monomer molecule.

Production of two of the most common types of polyamide, nylon 6 and nylon 6,6, reached 7.2 million tons in 2014. The applications of polyamides are broad and varied; ranging from automotive components, electronic products and coatings to filaments, yarns, packaging, sports equipment and appliances. Therefore, the demand and value of polyamides as a polymer is high and expected to increase. However, current annual production is primarily derived from petrochemical feedstocks. Demand for suitable bio-based monomer alternatives and renewable production on the industrial scale is growing, from both public consumers and industry. Furthermore, bulk of the commercial polyamide market is dominated by short-chain polyamides (namely, containing less than 10 carbons per repeating unit). These shorter-chained polyamides exhibit poor water stability and gas permeability properties, while their low number average molecular weights (Mn) (˜10,000-30,000 g·mol⁻¹) further limit optimal material properties and performance. Therefore, in order to meet these growing demands, while also addressing aforementioned material drawbacks (poor moisture stability and low molecular weight range), novel polyamide structures and pathways for their production are required.

US 2014/0039081 A1 discloses a process for the production of a thermoplastic polymer containing carbon and sulphur in an atomic ratio of C:S of at least 4 and at most 36, wherein at most 70% of the protons are present as aromatic hydrogen atoms. The process comprises the step of step growth thiolene addition polymerization of at least one unsaturated thiol as monomer, thereby forming at least one thioether (C—S—C) function.

Türünç and Meier (Macromol. Rapid Commun., 2010, 31; 1822-1826) describe the process of preparing sulphur-funcitonalised monomers for subsequent polyester production, via thiol-ene ‘click’ reactions. The reactions occur between thiol and alkyl functional groups, thereby forming at least one thioether (C—S—C) functional group.

Türünç et al (Green Chem., 2012, 14; 2577-2583) describe the preparation of AB-type sulphur-containing polyamides with a carbon number of up-to-and-including 12. Functional sulphur-containing monomers are prepared through a thiol-ene addition ‘click’ reaction between an aminothiol and unsaturated fatty acid derivative. The functional sulphur-containing monomers subsequently undergo self-polycondensation to yield sulphur containing AB-type polyamides.

Unverferth and Meier (European Journal of Lipid Science and Technology, 2016, 118; doi:10.1002/ejlt.201600003) describe the preparation of sulphur-containing, branched monomers via thiol-ene ‘click’ reactions between a dithiol and unsaturated fatty acid derivative. The functional sulphur-containing monomers were subsequently polymerized via polycondensation with hexamethylenediamine and dimethyl adipate to yield sulphur-containing co-polyamides.

The present invention provides novel, long-chain sulphur-containing polyamides utilising monomers obtained from renewable sources, with improved properties, and a method for the production thereof.

### Definitions

In the present invention,

the term ‘nylon salt’ means a crystalline solid which is obtained from the reaction between the dicarboxylic acid and diamine (base) prior to the polycondensation reaction;

the term “thiol-ene ‘click’ addition reaction” means a reaction between a thiol and alkene to yield an alkyl sulphide functional group;

the term “homopolymer” means that each repeating unit of formula I or formula II in the polyamide is identical to each other;

the term “copolymer” means that there are two or more different repeating units of formula I or formula II in the polyamide;

the term ‘renewable sources’ refers to origin from biomass, namely of from plants, animals or microorganisms, or biowaste and is different from fossil sources, which are derived from the organic remains of prehistoric microorganisms, plants and animals.

### BRIEF DESCRIPTION OF THE INVENTION

An object of the present invention is to provide aliphatic long chain polyamides which contain sulphur in their structure. The incorporation of sulphur into the backbone chain of polyamides presents several benefits. For example, the presence of sulphur atoms along the polyamide backbone chain enhances water barrier, permeation and chemical resistance properties of the polyamides. This further expands the applicability of polyamides to include high-end electronic devices, including organic light-emitting diode devices, components for charge-coupled devices (CCDs) and image sensors (CISs).

The polyamide of the invention is an AB-type or an AABB-type polyamide where A and B stand for the functional groups —NH₂ and —COOH, respectively. The AB-type polyamide is prepared via the self-polycondensation of a single functional monomer. The AABB-type polyamides are prepared via the polycondensation of two distinct molecules, that is a dicarboxylic acid and a diamine.

Another object of the invention is to provide a method for preparing AB-type polyamides containing sulphur.

Another object of the invention is to provide a method for preparing AABB-type polyamides containing sulphur.

In an aspect, the invention provides use of the polyamides of the invention or the polyamides prepared by the process of the invention, e.g., for high-end electronic devices, organic light-emitting diode devices, components for charge-coupled devices (CCDs) and image sensors (CISs), films and coatings, food packaging films, furniture, appliances, sports equipment, consumer goods, wire and cable, and automotive components.

The sulphur-containing polyamides provided by the invention can have higher molecular weight as than conventional polyamides, providing certain advantageous. Further, these sulphur-containing polyamides have superior strength and elongation values, good retention of physical properties above their softening temperature, superior water resistance and chemical resistance, superior barrier properties, low absorption of water, improved processability and excellent compatibility with polyolefins.

### BRIEF DESCRIPTION OF THE DRAWING

FIG. 1 shows DSC curves of a commercial polypropylene reference (PP), a sulphur-containing polyamide S-PA 6,24 of the invention (PAS 23h), and a blend of the two polymers (PAS:PP 90:10 wt %).

### DETAILED DESCRIPTION OF THE INVENTION

The AB-type sulphur-containing polyamide of the invention is a polymer prepared from the self-polycondensation, comprising a sulphur-containing monomer, possessing an amine group at the one end of the monomer chain and a carboxylic acid group at the other end of the monomer chain. In general, AB-type polyamides are typically described as “S-PA Z”, wherein ‘Z’ represents the number of carbon atoms of the sulphur-containing monomer. For example, S-PA 6 is prepared from a sulphur-containing monomer having 6 carbon atoms.

The AABB-type sulphur-containing polyamide of the invention is a polymer comprising a sulphur-containing diamine and/or a sulphur-containing dicarboxylic acid monomers. In general, AABB-type polyamides are typically described as “S-PA X,Y” wherein ‘X’ represents the number of carbon atoms derived from the diamine and ‘Y’ represents the number of carbon atoms derived from the dicarboxylic acid. For example, S-PA 4,14 is a polymer of C4 diamine and C14 dicarboxylic acid.

An object of the invention is to provide an aliphatic AB-type polyamide containing sulphur in its carbon chain. In an embodiment, the polyamide is an aliphatic AB-type polyamide

S-PA Z
in which Z is an integer from 5 to 42, specifically 5 to 36, more specifically 5 to 22, comprising at least one repeating unit having formula I:

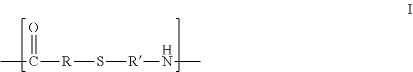

in which

R and R′ represent an aliphatic, saturated or unsaturated hydrocarbyl moiety, optionally containing oxygen in the hydrocarbon chain, in which the total number of the carbon atoms of R and R′ is Z−1.

In an embodiment, the AB-type sulphur-containing polyamide is selected from a group comprising S-PA 5, S-PA 6, S-PA 7, S-PA 8, S-PA 9, S-PA 10, S-PA 11, S-PA 12, S-PA 13, S-PA 14, S-PA 15, S-PA 16, S-PA 17, S-PA 18, S-PA 19, S-PA 20, S-PA 21, S-PA 22, S-PA 23, S-PA 24, S-PA 25, S-PA 26, S-PA 27, S-PA 28, S-PA 29, S-PA 30, S-PA 32, S-PA 34, S-PA 36, S-PA 38, S-PA 42. In another embodiment, the sulphur-containing polyamide is selected from a group comprising S-PA 12 and S-PA 13.

In an aspect, the invention provides a method for producing an aliphatic long chain sulphur containing AB-type polyamide S-PA Z, in which Z is an integer from 5 to 42, specifically 5 to 36, more specifically 5 to 22,

comprising the steps of:
providing an aliphatic alkenoic acid having a carbon chain length of C3 to C30, specifically of C3 to C18,
providing an aliphatic aminothiol having a carbon chain length of C2 to C12, optionally containing oxygen in the hydrocarbon chain,
combining the alkenoic acid and aminothiol in a 1:1 molar ratio to provide a sulphur-containing monomer via a thiol-ene ‘click’ addition reaction,
polymerizing the sulphur-containing monomer at a temperature above the melting point of the monomer to form a sulphur-containing polyamide,
cooling the sulphur-containing polyamide,
recovering the sulphur-containing polyamide.

In an embodiment, the mixture of the alkenoic acid and aminothiol is exposed to heat or UV light.

In an embodiment, the monomer is prepared via a thiol-ene (‘click’ chemistry) reaction in which an alkenoic acid of C3 to C30 and an aminothiol of C2 to C12 form a functional monomer with an amine group at the one end of the carbon chain and a carboxylic acid group at the other end of the carbon chain. The functional monomer thus also contains a sulphur atom along the main chain introduced to the polyamide via the amine component. The second step involves a self-condensation step in which the functional sulphur-containing monomer forms a sulphur-containing polyamide.

In another embodiment, sulphur is introduced to the polyamide via the acid component. In an embodiment, the monomer is prepared via a thiol-ene (‘click’ chemistry) reaction in which an thiol-acid, such as C1 to C24, and an unsaturated amine, such as of C3 to C12, form a functional monomer with an amine group at the one end of the carbon chain and a carboxylic acid group at the other end of the carbon chain. The functional monomer thus also contains a sulphur atom along the main chain introduced to the monomer via the amine component. The second step involves a self-condensation step in which the functional sulphur-containing monomer forms a sulphur-containing polyamide.

In a further embodiment, both the acid and the diamine components contain sulphur.

In an embodiment, the carbon chain length of the alkenoic acid is in the range of C3 to C30. In an embodiment, the alkenoic acid is acrylic acid having the formula

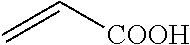

In an embodiment, the alkenoic acid is 9-decenoic acid having the formula

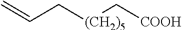

In another embodiment, the alkenoic acid is 10-undecenoic acid having the formula

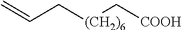

In another embodiment, the alkenoic acid is 13-tetradecenoic acid having the formula

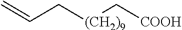

In an embodiment, the carbon chain length of the aminothiol is C2 to C12.

In an embodiment, the functional sulphur-containing monomer is prepared by mixing an alkenoic acid, such as 10-undecenoic acid (“10COOH”), with an aminothiol, such as cysteamine, in a molar ratio of 1:1 to form an amino-acid monomer. The reaction mechanism is shown below.

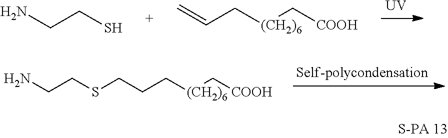

In a further aspect, the invention provides an aliphatic AABB-type polyamide

S-PA X,Y

in which
X is an integer from 1 to 30, specifically 2 to 24, more specifically 4 to 18, still more specifically 4 to 6,
Y is an integer from 3 to 72, specifically 8 to 60, more specifically 8 to 40, still more specifically 8 to 32;
comprising repeating units having formula II:

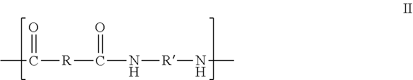

in which

R′ represents an aliphatic, saturated or unsaturated sulphur-containing hydrocarbyl moiety having 1 to 30, specifically 2 to 24, more specifically 4 to 18, still more specifically 4 to 6 carbon atoms, optionally containing oxygen in the hydrocarbon chain;

R represents an aliphatic, saturated or unsaturated, hydrocarbyl moiety having 1 to 70, specifically 6 to 58, more specifically 6 to 38, still more specifically 6 to 30 carbon atoms, optionally containing oxygen in its carbon chain;

in which at least one of R and R′ contains sulphur in its hydrocarbon chain.

In an embodiment, the AABB-type sulphur-containing polyamide is selected from a group comprising from a group comprising S-PA 4,8, S-PA 4,10, S-PA 4,12, S-PA 4,14, S-PA 4,16, S-PA 4,20, S-PA 4,22, S-PA 4,24, S-PA 4,26, S-PA 4,28, S-PA 4,30, S-PA 4,32, S-PA 4,34, S-PA 4,36, S-PA 4,38, S-PA 4,40, S-PA 4,44, S-PA 4,46, S-PA 4,48, S-PA 4,50, S-PA 4,52, S-PA 4,54, S-PA 4,56, S-PA 4,60, S-PA 4,62, S-PA 4,64, S-PA 4,68, S-PA 4,72, S-PA 6,8, S-PA 6,10, S-PA 6,12, S-PA 6,14, S-PA 6,16, S-PA 6,20, S-PA 6,22, S-PA 6,24, S-PA 6,26, S-PA 6,28, S-PA 6,30, S-PA 6,32, S-PA 6,34, S-PA 6,36, S-PA 6,38, S-PA 6,40, S-PA 6,44, S-PA 6,46, S-PA 6,48, S-PA 6,50, S-PA 6,52, S-PA 6,54, S-PA 6,56, S-PA 6,60, S-PA 6,62, S-PA 6,64, S-PA 6,68, S-PA 6,72, S-PA 8,8, S-PA 8,10, S-PA 8,12, S-PA 8,14, S-PA 8,16, S-PA 8,20, S-PA 8,22, S-PA 8,24, S-PA 8,26, S-PA 8,28, S-PA 8,30, S-PA 8,32, S-PA 8,34, S-PA 8,36, S-PA 8,38, S-PA 8,40, S-PA 8,44, S-PA 8,46, S-PA 8,48, S-PA 8,50, S-PA 8,52, S-PA 8,54, S-PA 8,56, S-PA 8,60, S-PA 8,62, S-PA 8,64, S-PA 8,68, S-PA 8,72, S-PA 11,8, S-PA 11,10, S-PA 11,12, S-PA 11,14, S-PA 11,16, S-PA 11,20, S-PA 11,22, S-PA 11,24, S-PA 11,26, S-PA 11,28, S-PA 11,30, S-PA 11,32, S-PA 11,34, S-PA 11,36, S-PA 11,38, S-PA 11,40, S-PA 11,44, S-PA 11,46, S-PA 11,48, S-PA 11,50, S-PA 11,52, S-PA 11,54, S-PA 11,56, S-PA 11,60, PA 11,62, S-PA 11,64, S-PA 11,68, S-PA 11,72, S-PA 12,8, S-PA 12,10, S-PA 12,12, S-PA 12,14, S-PA 12,16, S-PA 12,20, S-PA 12,22, S-PA 12,24, S-PA 12,26, S-PA 12,28, S-PA 12,30, S-PA 12,32, S-PA 12,34, S-PA 12,36, S-PA 12,38, S-PA 12,40, S-PA 12,44, S-PA 12,46, S-PA 12,48, S-PA 12,50, S-PA 12,52, S-PA 12,54, S-PA 12,56, S-PA 12,60, S-PA 12,62, S-PA 12,64, S-PA 12,68, S-PA 12,72, S-PA 14,8, S-PA 14,10, S-PA 14,12, S-PA 14,14, S-PA 14,16, S-PA 14,20, S-PA 14,22, S-PA 14,24, S-PA 14,26, S-PA 14,28, S-PA 14,30, S-PA 14,32, S-PA 14,34, S-PA 14,36, S-PA 14,38, S-PA 14,40, S-PA 14,44, S-PA 14,46, S-PA 14,48, S-PA 14,50, S-PA 14,52, S-PA 14,54, S-PA 14,56, S-PA 14,60, S-PA 14,62, S-PA 14,64, S-PA 14,68, S-PA 14,72, S-PA 16,8, S-PA 16,10, S-PA 16,12, S-PA 16,14, S-PA 16,16, S-PA 16,20, S-PA 16,22, S-PA 16,24, S-PA 16,26, S-PA 16,28, S-PA 16,30, S-PA 16,32, S-PA 16,34, S-PA 16,36, S-PA 16,38, S-PA 16,40, S-PA 16,44, S-PA 16,46, S-PA 16,48, S-PA 16,50, S-PA 16,52, S-PA 16,54, S-PA 16,56, S-PA 16,60, S-PA 16,62, S-PA 16,64, S-PA 16,68, S-PA 16,72, S-PA 18,8, S-PA 18,10, S-PA 18,12, S-PA 18,14, S-PA 18,16, S-PA 18,20, S-PA 18,22, S-PA 18,24, S-PA 18,26, S-PA 18,28, S-PA 18,30, S-PA 18,32, S-PA 18,34, S-PA 18,36, S-PA 18,38, S-PA 18,40, S-PA 18,44, S-PA 18,46, S-PA 18,48, S-PA 18,50, S-PA 18,52, S-PA 18,54, S-PA 18,56, S-PA 18,60, S-PA 18,62, S-PA 18,64, S-PA 18,68, S-PA 18,72. In another embodiment, the sulphur-containing polyamide is selected from a group comprising S-PA 6,24, S-PA 6,28, S-PA 6,32, S-PA 6,24, S-PA 12,28 and S-PA 12,32.

In an aspect, the invention provides a method for producing of an aliphatic long chain AABB-type sulphur-containing polyamide S-PA X,Y in which

X is an integer from 1 to 30, specifically 2 to 24, more specifically 4 to 18, still more specifically 4 to 6,

Y is an integer from 3 to 72, specifically 8 to 60, more specifically 8 to 40, still more specifically 8 to 32;

comprising the steps of:
providing an aliphatic alkenoic acid having a carbon chain length of C3 to C30, specifically C3 to C42, more specifically C3 to C18,
providing an aliphatic dithiol having a carbon chain length of C2 to C12, specifically C2 to C4, optionally containing oxygen in the hydrocarbon chain,
combining the alkenoic acid and dithiol in a 2:1 molar ratio to form a sulphur-containing dicarboxylic acid via a thiol-ene ‘click’ addition reaction,
providing an aliphatic, saturated or unsaturated diamine having a carbon chain length of C1 to C30, specifically C2 to C24, more specifically C4 to C18, still more specifically C4 to C6, optionally containing oxygen in its carbon chain,
dissolving the sulphur-containing dicarboxylic acid in an aqueous or organic solvent or a mixture thereof, such as in a lower alcohol of C1 to C4, e.g. ethanol,
mixing the alcoholic solution of the sulphur-containing dicarboxylic acid with the diamine to form a nylon salt precipitate,
polymerizing the nylon salt precipitate at a temperature above the melting point of the nylon salt to form a sulphur-containing polyamide,
cooling the sulphur-containing polyamide,
recovering the sulphur-containing polyamide.

Polymerisation can be conducted with or without catalysts. Suitable catalysts are, e.g. metal oxides and carbonates; strong acids; lead monoxide; terephthalate esters; acid mixtures and titanium alkoxide or carboxylates.

The dicarboxylic acids, alkenoic acids and diamines used in the preparation of both AB- and AABB-type sulphur-containing polyamides can originate from fossil or renewable sources. In an embodiment, the dicarboxylic acids, alkenoic acids and/or diamines are obtained from renewable sources. In an embodiment, the dicarboxylic acids, alkenoic acids and/or diamines are from renewable oils and fats such as vegetable oils comprising rapeseed oil, canola oil, castor oil, soy bean oil, palm oil, palm kernel oil, corn oil, coconut oil, sun flower oil, camelina oil, jatropha oil, thistle oil, olive oil, sesame oil, peanut oil, shea nut oil, poppy seed oil, melon seed oil, kapok seed oil, tallow tee oil, jojoba oil, linseed oil, hempseed oil, cottonseed oil, tung oil, tall oil, algae oil, microbial oil or animal fats or fish fats or yellow grease or brown grease, or used cooking oil, or sludge palm oil or spent bleaching earth oil, or renewable fatty acids such as palm oil fatty acid distillate or tall oil fatty acid distillate, or renewable waste oils, fats or fatty acids regarded as wastes or residues. In another embodiment of the invention the diacids, alkenoic acids and/or diamines are derived from carbohydrates of renewables sources, such as carbohydrates from lignocellulosic materials, starch crops or sugar crops. In yet another embodiment of the invention, the diacids, alkenoic acids and/or diamines are derived from lignocellulosic materials of renewable sources.

It is also possible to use carboxylic acid derivatives, such as acid esters or acid chlorides instead of carboxylic acids.

In an embodiment, the sulphur-containing dicarboxylic acid utilised in the synthesis of AABB-type sulphur-containing polyamides is prepared by reacting an alkenoic acid, such as 10-undecenoic acid (“10COOH”), with a dithiol, such as 1,2-ethanedithiol (EDT), in a molar ratio of 2:1 to form a sulphur-containing dicarboxylic acid. The reaction mechanism is shown below

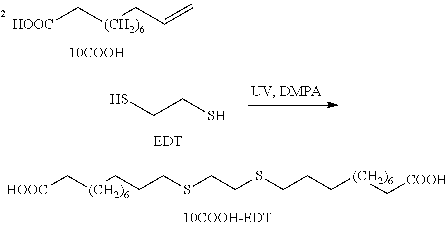

In an embodiment, the carbon chain length of the alkenoic acid is in the range of C3 to C30. In an embodiment, the alkenoic acid is 9-decenoic acid. In another embodiment, the alkenoic acid is 10-undecenoic acid. In a further embodiment, the alkenoic acid is 13-tetradecenoic acid.

In an embodiment, the sulphur-containing dicarboxylic acid is prepared by reacting a thiol-acid with of diene in a molar ratio of 2:1. The sulphur-containing dicarboxylic acid is subsequently reacted with a diamine via polycondensation to yield a sulphur-containing polyamide. In an embodiment, the carbon chain length of the thiol-acid is in the range of C1 to C30. In an embodiment, the thiol-acid acid is 12-mercaptododecanoic acid. In another embodiment, the thiol-acid is 16-mercaptohexadecanoic acid.

In an embodiment, S-PA X,Y polyamide is prepared by reacting a non-sulphur-containing dicarboxylic acid with a sulphur-containing diamine.

In an embodiment, the sulphur-containing diamine is prepared by reacting an unsaturated amine with of dithiol in a molar ratio of 2:1. The sulphur-containing diamine is subsequently reacted with a dicarboxylic acid via polycondensation to yield a sulphur-containing polyamide. In an embodiment, the carbon chain length of the unsaturated amine is in the range of C3 to C30. In an embodiment, the unsaturated amine is allylamine. In another embodiment, the unsaturated amine is 10-undecen-1-amine.

In an embodiment, the sulphur-containing diamine acid is prepared by reacting an amino thiol with of diene in a molar ratio of 2:1. The sulphur-containing diamine is subsequently reacted with a dicarboxylic acid via polycondensation to yield a sulphur-containing polyamide. In an embodiment, the carbon chain length of the amino thiol is in the range of C1 to C30. In an embodiment, the amino thiol is 3-amino-1-propanethiol. In another embodiment, the amino thiol is 6-Amino-1-hexanethiol. In another embodiment, the amino thiol is 8-amino-1-octanethiol. In another embodiment, the amino thiol is 16-amino-1-hexadecanethiol.

In an embodiment, S-PA X,Y polyamide is prepared by reacting a sulphur-containing dicarboxylic acid with a sulphur containing diamine. The preparation methods of a sulphur-containing dicarboxylic acids and sulphur containing diamines were described above.

In another embodiment, the dithiol may contain oxygen. In another embodiment, the dithiol is (ethylenedioxy)diethanethiol having the formula

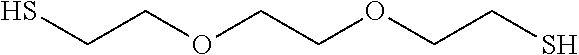

The diamine used for providing the AABB-type sulphur-containing polyamides of the invention is selected from aliphatic and aromatic diamines, optionally containing oxygen in their carbon chain. In an embodiment, the diamine is aliphatic. The aliphatic diamine can be linear, branched or cyclic. In one embodiment of the invention, the aliphatic diamine is linear. The diamine can be either saturated or unsaturated. In an embodiment, the diamine is saturated. The carbon chain length of the diamines is in the range of C1 to C30. In an embodiment, the carbon chain length is C4. In an embodiment of the invention the diamine is tetramethylene-1,4-diamine. In an embodiment, the carbon chain length is C6. In a further embodiment, the diamine is aliphatic saturated diamine with a chain length C6. In a further embodiment, the diamine is hexamethylene-1,6-diamine. In a still further embodiment, the polyamine is poly(ethylene glycol) diamine having the formula

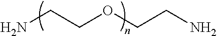

The dicarboxylic acid used for providing the AABB-type sulphur-containing polyamides of the invention is selected from aliphatic and aromatic dicarboxylic acids, optionally containing oxygen in their carbon chain. In an embodiment, the dicarboxylic acid is aliphatic. The aliphatic dicarboxylic acid can be linear, branched or cyclic. In one embodiment of the invention, the aliphatic dicarboxylic acid is linear. The dicarboxylic acid can be either saturated or unsaturated. In an embodiment, the dicarboxylic acid is saturated. The carbon chain length of the dicarboxylic acids is in the range of C3 to C72. In an embodiment, the carbon chain length is from C10 to C24. In a further embodiment, the dicarboxylic is hexadecanedioic acid. In a still further embodiment, the polyamide is poly(ethylene glycol) dicarboxylic acid having the formula

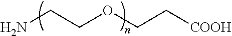

In an embodiment, S-PA X,Y polyamide is prepared by reacting a sulphur-containing dicarboxylic acid with a non-sulphur- or sulphur-containing diamine. Any method can be used for the polymerization of S-containing polyamides according to the invention.

In one embodiment of the invention, the sulphur-containing dicarboxylic acid is first dissolved in an alcohol. A lower C1 to C4 alcohol is suitable. In an embodiment, the alcohol is ethanol. To enhance the dissolution of the acid, heat treatment can be applied. The concentration of the diacid in the alcoholic solvent is in the range of 5 wt % to 60 wt %. In an embodiment, the concentration is 10 wt %.

The dicarboxylic acid dissolved in an alcohol is then mixed with the diamine whereby a precipitation, that is a ‘nylon salt’ is formed. The salt is removed, e.g. by filtration. In an embodiment, the recovered salt is purified, e.g. by washing with a lower alcohol of C1 to C4 such as ethanol. In further embodiment, the washing method can be boiling nylon salt in alcohol and then filtration or Soxhlet extraction method. The purification provides a high amount of a desirable dimer molecule, that is said nylon salt, whereby undesired trimers and contaminants are removed.

The stoichiometric amount of the monomers is important to control the molecular weight of the polyamide. In an embodiment, the molar ratio of the diamine to diacid is about 1:1. Improper stoichiometric balance can lead to a low molecular weight polyamide after a short polymerization time and premature termination of the polycondensation reaction. Stoichiometry is controlled by preparing the nylon salt in a precise 1:1 ratio of diacid:diamine.

The nylon salt, optionally purified, is then subjected to a polymerizing step at a temperature above the melting temperature of the nylon salt. In an embodiment, this temperature is about 5° C. to about 50° C. above the melting temperature of the nylon salt. In another embodiment, the polymerization is carried out at a temperature which is about 30° C. above the melting temperature of the nylon salt. The polymerization reaction is typically carried out at a temperature range of about 150° C. to about 250° C.

In general, the polycondensation reaction of a dicarboxylic acid with a diamine, involved in the method for producing AABB-type polyamides can be described as follows:

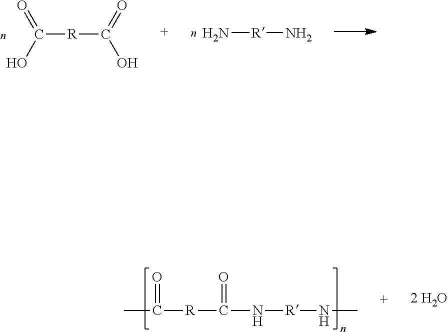

The polymerization degree of the polyamide is controlled by the reaction time. The reaction time is at least 2 hours in order to provide a polyamide with sufficiently high molecular weight. Typically, the polymerization time is in the range of 2 to 48 hours. During the polymerization, water is removed by vacuum.

After achieving the desired molecular weight of the polyamide, the polymerization reaction is terminated. Termination can be carried out, e.g., by cooling. The polymerization reaction can also be terminated by adjusting the concentration of the diamine and diacid so that one of the diamine and diacid is present in slight excess. The monomer present in a minor amount is consumed first and the monomer present in a major amount dominates the end of the polymer chains until no further polymerization is possible.

According to another embodiment of the invention, the polymer material according to the invention is a co-polymer comprising monomers that contain sulphur in their carbon chain. According to yet another embodiment of the invention, the co-polymer material comprises C6 aliphatic diacid monomers (such as adipic acid) and one of more of monomers containing sulphur in their carbon chain.

According to the invention, the polymer material is a co-polymer in which at least 5% of repeating units contain sulphur in their carbon chain, according to another embodiment of the invention at least 10%, or at least 20%, or at least 30%, invention at least 40% of repeating units contain sulphur in their carbon chain and according to yet another embodiment of the invention at least 50% of repeating units contain sulphur in their carbon chain.

Various characteristics of the sulphur-containing polyamides of the invention were measured. The analysis methods for each characteristic are described in more detail below.

In an embodiment, the sulphur-containing polyamides of the invention and the sulphur-containing polyamides prepared by the method of the invention have at least one of the following features:
water absorption in the range of 0.01% to 15%
melting point Tₘ in the range of 50° C. to 390° C.
Young's modulus in the range of 50 to 5000 MPa
molecular weight Mₙ up to 350000 g·mol⁻¹
tear strength in the range of 5 to 70 kN·m.

The sulphur-containing polyamides of the invention and the sulphur-containing polyamides prepared by the method of the invention are suitable for, but are not limited to, high-end electronic devices, including organic light-emitting diode devices, components for charge-coupled devices (CCDs) and image sensors (CISs); packing films, such as food packaging films; furniture; and constructions of cars. Furthermore, in case where the polyamides contain long aliphatic segments, the polyamides have an increased compatibility with the polyolefins compared with the conventional PA 6,6.

In an aspect, the invention provides use of the polyamides of the invention or the polyamides prepared by the process of the invention for packing films, such as food packaging films; furniture; and constructions of cars.

The following examples are presented for further illustration of the invention without limiting the invention thereto.

The water absorption content of the polyamide prepared in the following examples was measured as follows: The polyamide was soaked into distilled water for 4 days. After this, they were taken out and excess water from the surface of the samples was dried gently by tissue paper. The water absorption percentages were calculated by the ratio of the dried and wet samples.

The glass transition temperature (T_{g}), melting point (Tₘ), crystallinity temperature (T_{c}) and decomposition temperature (Td) of the sulphur-containing polyamide were measured by TA Q2000 Modulated Temperature DSC at 20° C./min heating rate and in the temperature range from −90° C. to 250° C. The thermal decomposition properties were determined by TA Q500 TGA at 20° C./min heating rate and in the temperature range from 30° C. to 800° C. The glass transition temperature was measured using TA Q800 DMA.

The tensile test was performed on a polyamide film specimen (5.3×20 mm) with a thickness of 0.1 mm using Instron 4204 Universal Tensile Tester with a 100 N static load cell in 50% humidity. The tensile force was increased gradually at 5 mm/min rate on the sample specimens. The measurements we conducted at three different temperatures, 30° C., 70° C. and 100° C.

Dynamic Mechanical Analysis (DMA) measurements were performed using TA Q800 DMA operating in tensile mode. A force rate of 3 N/min was applied on the sample specimens (films). The measurements we conducted at three different temperatures, 30° C., 70° C. and 100° C. Based on the plotted stress/strain curves, the Young's modulus of the samples were determined (the slopes of stress/strain curves). In addition to the Young's modulus, the glass transition temperatures were measured by DMA. The samples were heated from room temperature to 250° C. at 10° C./min, while subjected to 1 Hz frequency within a constant amplitude, 15 μm. The glass transition temperature was determined at the peak of Tan delta curve which is the ratio of the loss modulus and the storage modulus. Samples were analyzed in duplicate.

Size exclusion chromatography (SEC) analyses were performed at room temperature with a Waters 717plus Autosampler, Waters 515 HPLC pump, and a Waters 2414 refractive index (RI) detector. A set of two columns in series (HFIP-803 and HFIP-804 ‘Shodex’ columns, Showa Denko Europe GmbH.) was utilised. Hexafluoroisopropanol (HFIP) with 5 mM sodium trifluoroacetate (CF₃COONa) was used as eluent at 0.5 ml·min⁻¹, and calibration was done against PMMA standards. All samples were prepared at 1 mg·ml⁻¹ concentrations using the eluent solvent.

Impact strength was measured with a Zwick Pendulum impact tester, utilising an impact energy of 1 J. Specimens with average dimensions ˜80×10×5 mm³ were prepared utilising heated press treatment, after which a 45° v-notch with 2 mm depth was cut. The results presented are the average of five reproducible repeats.

Tear strength analysis was conducted utilising a modified trouser test. Rectangular specimens 20 mm in length and 12.5 mm wide were mounted with the longer dimension parallel to the direction of extension. A 10 mm notch was cut from the center of the specimen to one end resulting in two legs which were secured at opposite ends of the tensile geometry. An extension rate of 10 mm·min⁻¹ was used to deform the materials. The results are the average of 5 measurements.

### Example 1. Preparation of Sulphur-Containing Dicarboxylic Acid

10-undecenoic acid (10COOH) and 1,2-ethanedithiol (EDT) in a molar ratio of 2:1 were charged into a pre-dried bottle to provide an acid/dithiol mixture. In a separate beaker, 2,2-dimethoxy-2-phenylacetophenone (DMPA) photoinitiator, (1 mol-% based on the total amount of 10COOH) was dissolved in a minimum amount of acetonitrile and added to the acid/dithiol mixture. The whole mixture was entirely covered with aluminum foil to prevent light radiation. The mixture was stirred with a vortex mixer overnight, then poured into Petri dishes. The reaction mixture was irradiated with a 15 W lamp (λ=254 nm) for 10 min. A white solid was formed indicating the completion of the reaction. The product, 10COOH-EDT, was purified by dissolving at the boiling point (75° C.) and by recrystallizing from ethanol. Finally, the monomer product was dried overnight in a vacuum oven at 60° C.

### Example 2. Preparation of Sulphur-Containing AABB-Type Polyamide 6,24

The diacid monomer containing sulphur, prepared in Example 1 was used for the preparation of a sulphur-containing polyamide 6,24. The diacid was dissolved in absolute ethanol at approximately 70° C. to obtain a 10 wt % clear transparent solution. 5 mol % excess of hexamethylene-1,6-diamine (HMDA) in ethanol solution (0.5 g/ml) was added dropwise to the mixture of the diacid and diamine under stirring. A nylon salt precipitated as soon as it was formed, approximately after 10 min. After the addition was completed, the reaction mixture was continuously stirred at 70° C. for 30 min, following by 1 h at 0° C. (ice bath). The nylon salt thus obtained was filtered, and the filtrate was washed with ethanol. The nylon salt product was dried overnight in a vacuum oven at 60° C.

The nylon salt was charged into a stainless steel reactor at room temperature for polymerizing the nylon salt. The temperature was increased gradually from room temperature to 30° C. above the salt's melting point, that is to 250° C., under a nitrogen purge. After reaching 250° C., approximately after 20 min, the nitrogen purge was stopped, all valves of the reactor were closed, and said temperature was maintained for 2 h by heating under pressure. Nitrogen purge was applied again for 1 h to remove the major amount of water. Finally, medium-high vacuum (less than 0.07 mbar) was applied to remove any remaining water. The overall reaction time was 24 h, whereby sufficient molecular weight sulphur containing polyamide 6,24 polymer (“S-PA”) was achieved. The polymer was soaked into liquid nitrogen to cool down and to prevent thermal degradation.

### Example 3. Preparation of Sulphur-Containing AABB-Type Polyamide 6,26

The sulphur-containing dicarboxylic acid utilised to prepare sulphur-containing polyamide 6,26 was prepared from 10-undecenoic acid and 1,4-butanedithiol analogously to the sulphur-containing dicarboxylic acid described in Example 1. The preparation of sulphur-containing AABB-type polyamide 6,26 was identical to the method presented in Example 2, except that the sulphur-containing dicarboxylic acid was prepared as described in Example 3.

### Example 4. Preparation of Sulphur-Containing AABB-Type Polyamide 6,32

The sulphur-containing dicarboxylic acid utilised to prepare sulphur-containing polyamide 6,32 was prepared from 10-undecenoic acid and 1,10-decanedithiol analogously to the sulphur-containing dicarboxylic acid described in Example 1. The preparation of sulphur-containing AABB-type polyamide 6,32 was identical to the method presented in Example 2, except that the sulphur-containing dicarboxylic acid was prepared as described in Example 4.

### Example 5. Preparation of Sulphur-Containing Amino-Carboxylic Acid

10-undecenoic acid and 2-aminoethanethiol (AET) in a molar ratio of 1:1 were charged into a pre-dried bottle to provide a thiol/ene mixture. In a separate beaker, DMPA photoinitiator, (1 mol-% based on the total amount of 10-undecenoic acid) was dissolved in a minimum amount of acetonitrile and added to the thiol/ene mixture. The whole mixture was entirely covered with aluminum foil to prevent light radiation. The mixture was stirred with a vortex mixer overnight, then poured into Petri dishes. The reaction mixture was irradiated with a 15 W lamp (λ=254 nm) for 1 h. A white solid was formed indicating the completion of the reaction. The product, 10-undecenoic acid-AET, was purified by dissolving at the boiling point (75° C.) and by recrystallizing from ethanol. Finally, the monomer product was dried overnight in a vacuum oven at 60° C.

### Example 6. Preparation of Sulphur-Containing AB-Type Polyamide S-PA 13

The product, 10-undecenoic acid-AET, prepared from Example 5 was charged into a stainless steel reactor at room temperature for polymerizing the nylon salt. The temperature was increased gradually from room temperature to 30° C. above its melting point, that is 200° C., under a nitrogen purge. After reaching 200° C., approximately after 20 min, the nitrogen purge was stopped, all valves of the reactor were closed, and said temperature was maintained for 2 h by heating under pressure. Nitrogen purge was applied again for 1 h to remove the major amount of water. Finally, medium-high vacuum (less than 0.07 mbar) was applied to remove any remaining water. The overall reaction time was 24 h, whereby sufficient molecular weight sulphur containing polyamide S-PA 12 polymer was achieved. The polymer was soaked into liquid nitrogen to cool down and to prevent thermal degradation.

### Example 7. Preparation of Sulphur-Containing Amino-Carboxylic Acid

9-decenoic acid (DA) and 2-aminoethanethiol (AET) in a molar ratio of 1:1 were charged into a pre-dried bottle to provide a thiol/ene mixture. In a separate beaker, DMPA photoinitiator, (1 mol-% based on the total amount of DA) was dissolved in a minimum amount of acetonitrile and added to the thiol/ene mixture. The whole mixture was entirely covered with aluminum foil to prevent light radiation. The mixture was stirred with a vortex mixer overnight, then poured into Petri dishes. The reaction mixture was irradiated with a 15 W lamp (λ=254 nm) for 1 h. A white solid was formed indicating the completion of the reaction. The product, DA-AET, was purified by dissolving at the boiling point (75° C.) and by recrystallizing from ethanol. Finally, the monomer product was dried overnight in a vacuum oven at 60° C.

### Example 8. Preparation of Sulphur-Containing AB-Type Polyamide S-PA 12

The product, 10-undecenoic acid-AET, prepared from Example 5 was charged into a stainless steel reactor at room temperature for polymerizing the nylon salt. The temperature was increased gradually from room temperature to 30° C. above its melting point, that is 200° C., under a nitrogen purge. After reaching 200° C., approximately after 20 min, the nitrogen purge was stopped, all valves of the reactor were closed, and said temperature was maintained for 2 h by heating under pressure. Nitrogen purge was applied again for 1 h to remove the major amount of water. Finally, medium-high vacuum (less than 0.07 mbar) was applied to remove any remaining water. The overall reaction time was 24 h, whereby sufficient molecular weight sulphur containing polyamide S-PA 12 polymer was achieved. The polymer was soaked into liquid nitrogen to cool down and to prevent thermal degradation.

### Example 9. Preparation of Sulphur-Containing AABB-Type Polyamide 12,26

The sulphur-containing dicarboxylic acid utilised to prepare sulphur-containing polyamide 12,26 was prepared from 10-undecenoic acid and 1,4-butanedithiol analogously to the sulphur-containing dicarboxylic acid described in Example 1. The sulphur-containing AABB-type polyamide 6,26 was prepared from the obtained dicarboxylic acid and dodecamethylenediamine in a similar manner as in Example 2.

### Example 10. Preparation of Sulphur Containing AABB-Type Polyamide 12,32

The sulphur-containing dicarboxylic acid utilised to prepare sulphur-containing polyamide 12,32 was prepared from 10-undecenoic acid and 1,10-decanedithiol analogously to the sulphur-containing dicarboxylic acid described in Example 1. The sulphur-containing AABB-type polyamide 12,32 was prepared from the obtained dicarboxylic acid and dodecamethylenediamine in a similar manner as in Example 2

The water absorption ability of polyamides depends on the density degree of amide linkages on polymer chains. A low number of amide linkages leads to less moisture attraction. The water absorption abilities of the sulphur-containing polyamides of the invention prepared in the Examples and that of commercial PA6,6 (reference) are shown in Table 1.

TABLE 1

| Polyamide | Water absorption (%) |
|---|---|
| PA6,6 (reference) | 7.64 |
| S-PA 12 | 0.79 |
| S-PA 6,24 | 0.79 |
| S-PA 6,26 | 0.65 |
| S-PA 6,32 | 0.31 |
| S-PA 12,26 | 0.12 |
| S-PA 12,32 | 0.05 |

Thermal characteristics of the sulphur-containing polyamides prepared in the Examples and that of commercial PA 6,6 (reference) are shown in Table 3. The low melting points of S-PA of the invention prepared in the Examples provide improved processability, such as extrusion and injection moulding, allowing for lower processing temperatures and less energy input during processing. Furthermore, the lower glass transition temperatures extend the operational temperature of these polymers to cooler, even sub-zero, temperature ranges. Similarly, the S-containing polyamides exhibit a relatively higher degree of crystallinity compared with conventional polyamides, which could be attributed to sulphur acting as a potential nucleating site.

A distinct double melting peak was observed for samples S-PA 6,24, S-PA 6,28 and S-PA 6,32. The presence of two melting peaks is explained by the melting of two morphological regions, forms I and II. Form I is relatively fixed in the thermal process, while the form II melting temperature varies with annealing conditions and can either appear above or below Form I. Form I dominates the crystallization while form II corresponds to recrystallization during heating. Above glass transition temperature, the amorphous regions reach a maximum degree of flexibility, after which they can be aligned and transformed into crystallites, which contribute towards the total crystallinity of the polymer. These recrystallization peaks are also observed in other semi-crystalline polymers, for instance polypropylene. In some cases, only a single endotherm peak with a shoulder appears during melting process such as in S-PA 12,28 and S-PA 12,32. In these instances, the crystalline forms I and II may have similar structure, resulting in their melting peaks being close to each other; this often results in overlapping melting peaks.

TABLE 2

| Polyamide | T_{g} (° C.) | T_{c} (° C.) | Tₘ (° C.) | T_{d} (° C.) |
|---|---|---|---|---|
| PA6,6 (reference)* | 50 | 219 | 259 | 465 |
| S-PA 12 | 23 | 103 | 133 | 408 |
| S-PA 6,24 | 34 | 153 | 128, 169 | 420 |
| S-PA 6,28 | 31 | 117 | 128, 146 | 435 |
| S-PA 6,32 | 32 | 117 | 126, 141 | 439 |
| S-PA 12,28 | 35 | 113 | 147 | 440 |
| S-PA 12,32 | 31 | 107 | 142 | 440 |

*Melvin I. Kohan, Nylon Plastics Handbook, Hanser Publishers, 1995

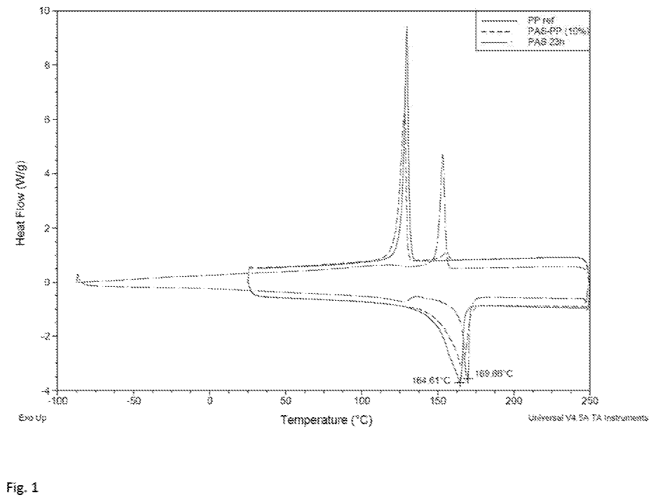

FIG. 1 shows DSC curves of a commercial polypropylene reference (PP), the sulphur-containing polyamide S-PA 6,24 prepared in Example 2 (PAS 23h), and a blend of the two polymers (PAS:PP 90:10 wt %). Both the S-PA and PP display distinct individual melting peaks, however the blend exhibits a single peak occupying the temperature range between those of the blend components. This indicates excellent miscibility of S-PA with PP and other polyolefins.

Table 3 shows the solubility of the sulphur-containing polyamides prepared in the Examples. The polyamides showed resistance to a range of common solvents (as indicated by the negative signs), dissolving only in specific solvent blends.

TABLE 3

| | PA | PA | PA | S-PA | S-PA | S-PA | S-PA | S-PA | S-PA |
|---|---|---|---|---|---|---|---|---|---|
| Solvent | 6, 6* | 12* | 6, 12* | 12 | 6, 24 | 6, 26 | 6, 32 | 12, 26 | 12, 32 |
| THF (tetrahydrofuran) | − | − | − | − | − | − | − | − | − |
| DMF(dimethylformamide) | − | − | − | − | − | − | − | − | − |
| CHCl₃ (chloroform) | − | − | − | − | − | − | − | − | − |
| NMP (N-methylpyrrolidone) | − | − | − | | − | − | − | − | − |
| Formic Acid | + | − | + | − | − | − | − | − | − |
| DMSO (dimethylsulfoxide) | − | − | − | − | − | − | − | − | − |
| CHCl₃/trifluoroacetic | + | + | + | + | + | + | + | + | + |
| anhydride | | | | | | | | | |
| Methanesulfonic Acid | + | + | + | + | + | + | + | + | + |
| Formic Acid/CHCl₃ | + | + | + | + | − | − | − | − | − |

* Melvin I. Kohan, Nylon Plastics Handbook, Hanser Publishers, 1995.

The results of tensile testing performed on sulphur-containing polyamides prepared in the Examples, and polyamide 6,6 and 6,12 references are shown in Table 4. Sulphur containing polyamides exhibited a high elongation at break, elongation at yield and work-to-break values, indicative of high toughness, resistance to deformation and ductility.

TABLE 4

| | Young's | Tensile | | Elongation | Elongation | |
|---|---|---|---|---|---|---|
| | modulus | strength | Yield strength at | yield | at break | Work-to-break |
| Polyamide | (MPa) | (MPa) | (MPa) | (%) | (%) | (MJ · m⁻³) |
| PA6, 6 | 3200 | 83 | 83 | 5 | 60 | 25 |
| (reference)* | | | | | | |
| PA6, 12 | 1170 | 49 | 49 | 25 | 100 | 38 |
| (commercial)* | | | | | | |
| S-PA 12 | 800 | 40 | 36 | 26 | 400 | 146 |
| S-PA 6, 24 | 450 | 32 | 29 | 26 | 600 | 173 |
| S-PA 6, 28 | 328 | 27 | 22 | 29 | 590 | 134 |
| S-PA 6, 32 | 271 | 24 | 20 | 44 | 550 | 120 |
| S-PA 12, 28 | 330 | 30 | 25 | 35 | 650 | 150 |
| S-PA 12, 32 | 290 | 25 | 25 | 45 | 550 | 124 |

*Melvin I. Kohan, Nylon Plastics Handbook, Hanser Publishers, 1995

The results of tensile testing performed at elevated temperatures on sulphur-containing polyamides prepared in the Examples are shown in Table 5. The results show that the polyamides retained a degree of mechanical strength and integrity above the glass transition temperature, indicative of the mechanical stability of the polyamide.

TABLE 5

| | Young's modulus (MPa) | | |
|---|---|---|---|
| Polyamide | 30° C. | 70° C. | 100° C. |
| S-PA 6,24 | 799 | 341 | 224 |
| S-PA 6,28 | 449 | 196 | 96 |
| S-PA 6,32 | 417 | 199 | 123 |
| S-PA 12,28 | 537 | 225 | 140 |
| S-PA 12,32 | 315 | 195 | 77 |
| S-PA 12 | 493 | 266 | 103 |

Results from SEC analysis are given in Table 6.

TABLE 6

| Polyamide | Mₙ (g · mol⁻¹) | M_{w} (g · mol⁻¹) | PDI |
|---|---|---|---|
| PA6,6 (Sigma) * | 68,000 | 109,000 | 1.60 |
| PA6,10 (Du Pont 3060) * | 31,500 | 71,000 | 2.25 |
| PA6,12 (Sigma) * | 12,000 | 24,000 | 2.05 |
| PA10,10 (Du Pont 1000) * | 20,000 | 67,000 | 3.27 |
| S-PA 6,24 | 8,000 | 34,000 | 4.17 |
| S-PA 6,28 | 18,000 | 75,000 | 4.11 |
| S-PA 6,32 | 42,000 | 270,000 | 6.39 |
| S-PA 12,28 | 55,000 | 298,000 | 5.45 |
| S-PA 12,32 | 48,000 | 189,000 | 3.90 |

* Commercial polyamide references

The bulk of the commercial PAs exhibited Mₙ values in the range of 12,000-31,000 g·mol⁻¹, which is quite typical of commercial polyamide grades. A noticeable exception was the PA 6,6 (Sigma) which yielded a maximum commercial Mₙ value of 68,000 g·mol⁻¹. The sulphur-containing polyamides possessed a Mₙ range of 8,000-55,000 g·mol⁻¹. This increased number average molecular weight can be attributed to the synergy of a number of factors. Firstly, the extended reaction times were used in the preparation of the S-PAs of the invention (≥20 h). This is much longer than conventional polycondensation times of 3-10 h used for commercial production of PA. Furthermore, effective water removal and mechanical agitation during the polycondensation reaction encourage chain growth and reduce the likelihood of chain scission (degradation) or reaction termination.

When comparing the M_{w} and PDI behaviour, the S-PAs displayed remarkably higher values on average than their commercial counterparts. This confirms that significant segments of very-high molecular weight polymer chains are present within the greater polymer network. These broad PDI and high M_{w} values indicate the reaction time, mixing and effectiveness of water (condensate) removal during polycondensation were appropriate and effective.

Results from impact strength analysis are given in Table 7.

TABLE 7

| Polyamide | Impact strength (kJ · m²) |
|---|---|
| PA6,6 (Sigma) * | 13.8 ± 5.3 |
| PA6,10 (Du Pont 3060) * | 28 ± 7.2 |
| PA10,10 (Du Pont 1000) * | 29 ± 4.4 |
| S-PA 6,24 | Unbreakable |

* Commercial polyamide references

The results show that commercial polyamides displayed impact strength values in the range 13-29 kJ·m². The long chain PA 6,18 displayed a significant increase in impact strength with a value of 83.6 kJ·m². In contrast, S-PA 6,24 could not be broken by the analysis device, even with the highest energy-level hammer (5 J). This enhancement in impact resistance is derived from both the increased molecular weight and molecular weight distribution of the sulphur-containing polyamides of the invention. Furthermore, the increased volume of chain entanglements between fractions of very high molecular weight S-PAs contributes towards energy absorption upon impact. However, the increased ductility and elongation due to reduced interchain hydrogen bonding encourages dissipation of applied energy through various chain motions rather than breakage or failure.

Results from tear strength analysis are given in Table 8.

TABLE 8

| Polyamide | Tear strength (kN · m) |
|---|---|
| PA6,6 (Sigma) * | 13.8 |
| PA6,10 (Du Pont 3060) * | 28 |
| PA10,10 (Du Pont 1000) * | 25 |
| S-PA 12 | 25 |
| S-PA 6,24 | 25 |
| S-PA 6,28 | 40 |
| S-PA 6,32 | 50 |
| S-PA 12,28 | 40 |
| S-PA 12,32 | 45 |

* Commercial polyamide references

Commercial polyamides generally displayed tear strength values in the range of 15-20 kN·m, PA 10,10 displaying a maximum tear strength values of 25 kN·m. Sulphur-containing polyamides of the invention displayed a remarkable increase in tear strength, exhibiting values in the range of 25-50 kN·m. Tear resistance behaviour is dominated by various factors, including branching, crystallinity, molecular weight and molecular weight distribution. Since all commercial and polyamides of the invention were linear and yielded crystallinity values within a similar range, the influence of these factors can be considered minimal. Rather, the increased molecular weight and molecular weight distribution of the polyamides of the invention are evident variables. As molecular weight- and distribution are increased, two main phenomena occur; namely 1) increased likelihood of chain entanglement and 2) a slower time-scale of motion. This enables the polyamide chain to better resist deformation under increased loads. Furthermore, the increased ductility and elongation at break of the polyamides of the invention contributes towards increased resistance to tear by allowing dissipation of applied load through chain slippage and other motions, rather than breakage. This is encouraged by the reduced number of amide linkages per repeat unit, which leads to a net reduction in the likelihood of interchain hydrogen bonding.

The larger atomic radius of the sulphur atoms prevents effective packing of polyamide chains, which prevents the already-limited occurrence of interchain H-bonding. This reduction in packing efficiency also serves to increase the amount of potential ‘free volume’/unoccupied space within the polyamide network, thus allowing a greater volume for chain sliding and other motions during periods of applied load.

It will be obvious to a person skilled in the art that, as the technology advances, the inventive concept can be implemented in various ways. The invention and its embodiments are not limited to the examples described above but may vary within the scope of the claims.

1. Aliphatic long chain polyamide (PA) containing sulphur.

2. The polyamide of claim 1, wherein the polyamide is an AB-type polyamide S-PA Z in which Z is an integer from 5 to 42, and comprises:
at least one repeating unit having formula I: 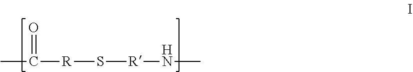
in which
R and R′ represent an aliphatic, saturated or unsaturated hydrocarbyl moiety, optionally containing oxygen in the hydrocarbon chain, in which a total number of carbon atoms of R and R′ is Z−1.

3. The polyamide of claim 2, wherein the sulphur-containing polyamide is at least one of S-PA 5, S-PA 6, S-PA 7, S-PA 8, S-PA 9, S-PA 10, S-PA 11, S-PA 12, S-PA 13, S-PA 14, S-PA 15, S-PA 16, S-PA 17, S-PA 18, S-PA 19, S-PA 20, S-PA 21, S-PA 22, S-PA 23, S-PA 24, S-PA 25, S-PA 26, S-PA 27, S-PA 28, S-PA 29, S-PA 30, S-PA 32, S-PA 34, S-PA 36, S-PA 38, S-PA 42, S-PA 12 or S-PA 13.

4. The polyamide of claim 1, wherein the polyamide is an AABB-type polyamide
S-PA X,Y in which X is an integer from 1 to 30, Y is an integer from 3 to 72 comprising:
repeating units having formula II: 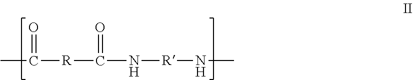
in which
R′ represents an aliphatic, saturated or unsaturated sulphur-containing hydrocarbyl moiety having 1 to 30 carbon atoms, optionally containing oxygen in the hydrocarbon chain;
R represents an aliphatic, saturated or unsaturated, hydrocarbyl moiety having 1 to 70 carbon atoms, optionally containing oxygen in its carbon chain;
in which at least one of R and R′ contains sulphur in its hydrocarbon chain.

5. The polyamide of claim 4, wherein the sulphur-containing polyamide is at least one of S-PA 4,8, S-PA 4,10, S-PA 4,12, S-PA 4,14, S-PA 4,16, S-PA 4,20, S-PA 4,22, S-PA 4,24, S-PA 4,26, S-PA 4,28, S-PA 4,30, S-PA 4,32, S-PA 4,34, S-PA 4,36, S-PA 4,38, S-PA 4,40, S-PA 4,44, S-PA 4,46, S-PA 4,48, S-PA 4,50, S-PA 4,52, S-PA 4,54, S-PA 4,56, S-PA 4,60, S-PA 4,62, S-PA 4,64, S-PA 4,68, S-PA 4,72, S-PA 6,8, S-PA 6,10, S-PA 6,12, S-PA 6,14, S-PA 6,16, S-PA 6,20, S-PA 6,22, S-PA 6,24, S-PA 6,26, S-PA 6,28, S-PA 6,30, S-PA 6,32, S-PA 6,34, S-PA 6,36, S-PA 6,38, S-PA 6,40, S-PA 6,44, S-PA 6,46, S-PA 6,48, S-PA 6,50, S-PA 6,52, S-PA 6,54, S-PA 6,56, S-PA 6,60, S-PA 6,62, S-PA 6,64, S-PA 6,68, S-PA 6,72, S-PA 8,8, S-PA 8,10, S-PA 8,12, S-PA 8,14, S-PA 8,16, S-PA 8,20, S-PA 8,22, S-PA 8,24, S-PA 8,26, S-PA 8,28, S-PA 8,30, S-PA 8,32, S-PA 8,34, S-PA 8,36, S-PA 8,38, S-PA 8,40, S-PA 8,44, S-PA 8,46, S-PA 8,48, S-PA 8,50, S-PA 8,52, S-PA 8,54, S-PA 8,56, S-PA 8,60, S-PA 8,62, S-PA 8,64, S-PA 8,68, S-PA 8,72, S-PA 11,8, S-PA 11,10, S-PA 11,12, S-PA 11,14, S-PA 11,16, S-PA 11,20, S-PA 11,22, S-PA 11,24, S-PA 11,26, S-PA 11,28, S-PA 11,30, S-PA 11,32, S-PA 11,34, S-PA 11,36, S-PA 11,38, S-PA 11,40, S-PA 11,44, S-PA 11,46, S-PA 11,48, S-PA 11,50, S-PA 11,52, S-PA 11,54, S-PA 11,56, S-PA 11,60, PA 11,62, S-PA 11,64, S-PA 11,68, S-PA 11,72, S-PA 12,8, S-PA 12,10, S-PA 12,12, S-PA 12,14, S-PA 12,16, S-PA 12,20, S-PA 12,22, S-PA 12,24, S-PA 12,26, S-PA 12,28, S-PA 12,30, S-PA 12,32, S-PA 12,34, S-PA 12,36, S-PA 12,38, S-PA 12,40, S-PA 12,44, S-PA 12,46, S-PA 12,48, S-PA 12,50, S-PA 12,52, S-PA 12,54, S-PA 12,56, S-PA 12,60, S-PA 12,62, S-PA 12,64, S-PA 12,68, S-PA 12,72, S-PA 14,8, S-PA 14,10, S-PA 14,12, S-PA 14,14, S-PA 14,16, S-PA 14,20, S-PA 14,22, S-PA 14,24, S-PA 14,26, S-PA 14,28, S-PA 14,30, S-PA 14,32, S-PA 14,34, S-PA 14,36, S-PA 14,38, S-PA 14,40, S-PA 14,44, S-PA 14,46, S-PA 14,48, S-PA 14,50, S-PA 14,52, S-PA 14,54, S-PA 14,56, S-PA 14,60, S-PA 14,62, S-PA 14,64, S-PA 14,68, S-PA 14,72, S-PA 16,8, S-PA 16,10, S-PA 16,12, S-PA 16,14, S-PA 16,16, S-PA 16,20, S-PA 16,22, S-PA 16,24, S-PA 16,26, S-PA 16,28, S-PA 16,30, S-PA 16,32, S-PA 16,34, S-PA 16,36, S-PA 16,38, S-PA 16,40, S-PA 16,44, S-PA 16,46, S-PA 16,48, S-PA 16,50, S-PA 16,52, S-PA 16,54, S-PA 16,56, S-PA 16,60, S-PA 16,62, S-PA 16,64, S-PA 16,68, S-PA 16,72, S-PA 18,8, S-PA 18,10, S-PA 18,12, S-PA 18,14, S-PA 18,16, S-PA 18,20, S-PA 18,22, S-PA 18,24, S-PA 18,26, S-PA 18,28, S-PA 18,30, S-PA 18,32, S-PA 18,34, S-PA 18,36, S-PA 18,38, S-PA 18,40, S-PA 18,44, S-PA 18,46, S-PA 18,48, S-PA 18,50, S-PA 18,52, S-PA 18,54, S-PA 18,56, S-PA 18,60, S-PA 18,62, S-PA 18,64, S-PA 18,68, S-PA 18,72, S-PA 6,24, S-PA 6,28, S-PA 6,32, S-PA 6,24, S-PA 12,28 or S-PA 12,32.

6. A method for producing an aliphatic long chain sulphur-containing AB-type polyamide S-PA Z, in which Z is an integer from 5 to 42, the method comprising:
providing an aliphatic alkenoic acid having a carbon chain length of C3 to C30;
providing an aliphatic aminothiol having a carbon chain length of C2 to C12, optionally containing oxygen in the hydrocarbon chain;
combining the alkenoic acid and aminothiol in a 1:1 molar ratio to provide a sulphur-containing monomer via a thiol-ene ‘click’ addition reaction;
polymerizing the sulphur-containing monomer at a temperature above a melting point of the monomer to form a sulphur-containing polyamide;
cooling the sulphur-containing polyamide; and
recovering the sulphur-containing polyamide.

7. A method for producing of an aliphatic long chain AABB-type sulphur-containing polyamide S-PA X,Y in which X is an integer from 1 to 30, and Y is an integer from 3 to 72, the method comprising:
providing an aliphatic alkenoic acid having a carbon chain length of C3 to C30;
providing an aliphatic dithiol having a carbon chain length of C2 to C12, optionally containing oxygen in the hydrocarbon chain;
combining the alkenoic acid and dithiol in a 2:1 molar ratio to form a sulphur-containing dicarboxylic acid via a thiol-ene ‘click’ addition reaction;
providing an aliphatic, saturated or unsaturated diamine having a carbon chain length of C1 to C30, optionally containing oxygen in its carbon chain;
dissolving the sulphur-containing dicarboxylic acid in an aqueous or organic solvent or a mixture thereof, such as in a lower alcohol of C1 to C4;
mixing the alcoholic solution of the sulphur-containing dicarboxylic acid with the diamine to form a nylon salt precipitate;
polymerizing the nylon salt precipitate at a temperature above a melting point of the nylon salt to form a sulphur-containing polyamide;
cooling the sulphur-containing polyimide; and
recovering the sulphur-containing polyamide.

8. The method of claim 7, wherein at least one of the dicarboxylic acid, alkenoic acid or diamine is from renewable vegetable oils or fats, carbohydrates or lignocellulosic materials.

9. The method of claim 6, wherein the polymerization is carried out at a temperature range of about 150° C. to about 250° C.

10. The method of claim 6, wherein a polymerization time is in a range of 2 to 48 hours.

11. The method of claim 7, wherein a molar ratio of dicarboxylic acid to diamine is about of 1:1.

12. The polyamide according to claim 2, wherein the R and R′ is a linear aliphatic hydrocarbyl moiety.

13. The polyamide of claim 2, wherein the polyamide is a homopolymer.

14. The polyamide of claim 1, wherein the polyamide is a copolymer.

15. The polyamide or the method of claim 1, wherein the polyamide is a copolymer in which at least 5%, of repeating units contain sulphur in their carbon chain.

16. The polyamide of claim 1, combination with at least one of a high-end electronic device, organic light-emitting diode device, a component for a charge-coupled device (CCD) or image sensor (SIC), a film, a coating, a food packaging film, a furniture, appliance, a sport equipment, a consumer good, a wire or cable, or an automotive component.

17. The polyamide of claim 1, wherein the polyamide is an AB-type polyamide S-PA Z in which Z is an integer from 5 to 36, and comprises:
at least one repeating unit having formula I: 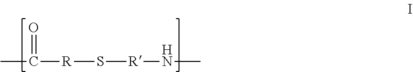
in which
R and R′ represent an aliphatic, saturated or unsaturated hydrocarbyl moiety, optionally containing oxygen in the hydrocarbon chain, in which the a total number of carbon atoms of R and R′ is Z−1.

18. The polyamide of claim 1, wherein the polyamide is an AB-type polyamide S-PA Z in which Z is an integer from 5 to 22, comprising:
at least one repeating unit having formula I: 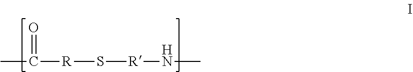
in which
R and R′ represent an aliphatic, saturated or unsaturated hydrocarbyl moiety, optionally containing oxygen in the hydrocarbon chain, in which the a total number of carbon atoms of R and R′ is Z−1.

19. The polyamide of claim 1, wherein the polyamide is an AABB-type polyamide S-PA X,Y in which X is an integer from 4 to 6, Y is an integer from 8 to 32 comprising:
repeating units having formula II: 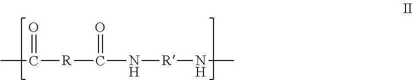
in which
R′ represents an aliphatic, saturated or unsaturated sulphur-containing hydrocarbyl moiety having 4 to 6 carbon atoms, optionally containing oxygen in the hydrocarbon chain;
R represents an aliphatic, saturated or unsaturated, hydrocarbyl moiety having 6 to 30 carbon atoms, optionally containing oxygen in its carbon chain;
in which at least one of R and R′ contains sulphur in its hydrocarbon chain.

20. A method for producing an aliphatic long chain sulphur-containing AB-type polyamide S-PA Z, in which Z is an integer from 5 to 22, the method comprising:
providing an aliphatic alkenoic acid having a carbon chain length of C3 to C18;
providing an aliphatic aminothiol having a carbon chain length of C2 to C12, optionally containing oxygen in the hydrocarbon chain;
combining the alkenoic acid and aminothiol in a 1:1 molar ratio to provide a sulphur-containing monomer via a thiol-ene ‘click’ addition reaction;
polymerizing the sulphur-containing monomer at a temperature above a melting point of the monomer to form a sulphur-containing polyamide;
cooling the sulphur-containing polyamide; and
recovering the sulphur-containing polyamide.

21. A method for producing of an aliphatic long chain AABB-type sulphur-containing polyamide S-PA X,Y in which X is an integer from 4 to 6, and Y is an integer from 8 to 32, the method comprising:
providing an aliphatic alkenoic acid having a carbon chain length of C3 to C18;
providing an aliphatic dithiol having a carbon chain length of C2 to C4, optionally containing oxygen in the hydrocarbon chain;
combining the alkenoic acid and dithiol in a 2:1 molar ratio to form a sulphur-containing dicarboxylic acid via a thiol-ene ‘click’ addition reaction;
providing an aliphatic, saturated or unsaturated diamine having a carbon chain length of C4 to C6, optionally containing oxygen in its carbon chain;
dissolving the sulphur-containing dicarboxylic acid in an aqueous or organic solvent or a mixture thereof, such as in a lower alcohol of C1 to C4;
mixing the alcoholic solution of the sulphur-containing dicarboxylic acid with the diamine to form a nylon salt precipitate;
polymerizing the nylon salt precipitate at a temperature above a melting point of the nylon salt to form a sulphur-containing polyamide;
cooling the sulphur-containing polyamide; and
recovering the sulphur-containing polyamide.
